(19) United States
(12) Patent Application Publication
(10) Pub. No.: US 2021/0354353 A1
(43) Pub. Date: Nov. 18, 2021

(54) COMPOSITE MOLDED ARTICLE

(71) Applicant: Polyplastics Co., Ltd., Tokyo (JP)

(72) Inventors: Akihiro MOCHIZUKI, Shizuoka (JP); Kohshi MIOKI, Shizuoka (JP)

(21) Appl. No.: 17/309,370

(22) PCT Filed: Jan. 16, 2020
(86) PCT No.: PCT/JP2020/001243

§ 371 Date: May 21, 2021

(30) Foreign Application Priority Data
Jan. 25, 2019 (JP) 2019-010821

(51) Int. Cl. B29C 45/14; C08K 7/14; C08K 3/40; C08K 3/04; C08K 13/04; B29B 11/08; B29B 11/16

(52) U.S. Cl. CPC B29C 45/14786; C08K 7/14; C08K 3/40; C08K 3/04; B29K 2309/08; B29B 11/08; B29B 11/16; C08K 2201/014; C08K 13/04

(57) ABSTRACT

A resin molded article that has a high bond strength in a composite molded article in which a first molded article and a second molded article are integrated, and that has a stable and uniform bond strength of a composite molded article between shots of the molded article. The composite molded article includes a grooved first resin molded article containing at least a resin, a glass fiber, and a laser absorption material, and having grooves that expose the glass fiber; and a second molded article adjacently disposed on the grooved surface of the first resin molded article. In the first resin molded article, the glass fiber is added in an amount of 12-45 mass % with respect to the total mass of the resin composition that constitutes the resin molded article, the laser absorption material is added in an amount of 0.25-10 mass % with respect to the total mass of the resin composition, and the glass fiber and the laser absorption material are blended within specific blending ranges.

### TECHNICAL FIELD

The present invention relates to a grooved first resin molded article, and a composite molded article including the grooved first resin molded article.

### BACKGROUND ART

In recent years, in the fields of automobiles, electronic products, industrial equipment and the like, there is an increasing trend of replacing a portion of a metal molded article with a resin molded article in order to respond to demands of reducing carbon dioxide emission, manufacturing costs, and the like. In connection with this, composite molded articles are widely used in which resin molded articles are integrated with metal molded articles. Not only these, but also composite molded articles in which molded articles formed of a material of the same type or different types are integrated together are also widely used.

As a method of manufacturing a composite molded article in which a first resin molded article and a second molded article are integrated, Patent Document 1 proposes that a laser is irradiated on a surface of the first resin molded article containing an inorganic filler to form a groove structure in which the inorganic filler is exposed on the surface, and then, another resin molded article is filled in contact with the surface, molded, and integrated.
Patent Document 1: PCT International Publication No. WO2015/146767

### DISCLOSURE OF THE INVENTION

### Problems to be Solved by the Invention

However, when forming the groove structure in a resin molded article by irradiation with a laser, a state of attenuation of a laser due to absorption or scattering changes depending upon the shape or addition amount of an inorganic filler such as glass fiber or a blending agent which is mixed into the resin so that a laser is absorbed. This will affect a forming state of the groove structure and thus a joint state of the composite molded article.

In particular, in a case in which the power of laser irradiation should be reduced due to circumstances such as avoiding deterioration of a resin portion or equipment limitations, variations in the dispersion and/or orientation state of the inorganic filler and/or blending agent during molding shots of the first resin molded article tend to affect the formation of the groove structure. As a result, variations in joint strength occur in some cases, resulting in a composite molded article having a poor yield and inferior productivity.

The present invention has been made to solve the above problems, and it is an object of the present invention to provide a composite molded article in which strength is stable with respect to molding shots and variations in the strength are small, while maintaining the strength when the first resin molded article and the second molded article are joined.

### Means for Solving the Problems

The object of the present invention has been achieved by the following. A first aspect of the present invention relates to a composite molded article including: a grooved first resin molded article including at least a resin, a glass fiber, and a laser absorbing material and having a groove in which the glass fiber is exposed, and a second molded article disposed adjacent to a grooved surface of the first resin molded article, in which, in the first resin molded article, the glass fiber is mixed in a content of 12 to 45 mass % with respect to an entirety of a resin composition constituting the resin molded article, and the laser absorbing material is mixed in a content of 0.25 to 10 mass % with respect to the entirety of the resin composition constituting the resin molded article, and in which [{amount (mass %) of the glass fiber contained in the resin composition constituting the first resin molded article×0.9}+{amount (mass %) of the laser absorbing material contained in the resin composition constituting the first resin molded article×1.4}]-{melt viscosity (Pa·s) of a material constituting the second molded article+360}/{average diameter (μm) of the glass fiber contained in the resin composition constituting the first resin molded article×0.8} satisfies 700 or more and 2,500 or less.

A second aspect of the present invention is the composite molded article as described in the first aspect, in which the glass fiber is mixed in a content of 20 to 38 mass % with respect to the entire resin composition constituting the first resin molded article, and the laser absorbing material is mixed in a content of 0.35 to 9 mass % with respect to the entire resin composition constituting the first resin molded article. A third aspect of the present invention relates to the composite molded article as described in the first or second aspect, in which [{amount (mass %) of the glass fiber contained in the resin composition constituting the first resin molded article×0.9}+{amount (mass %) of the laser absorbing material contained in the resin composition constituting the first resin molded article×1.4}]×{melt viscosity (Pa·s) of the material constituting the second molded article+360}/{average diameter (μm) of the glass fiber contained in the resin composition constituting the first resin molded article×0.8} satisfies 1,200 or more and 2,100 or less.

### Effects of the Invention

According to the present invention, it is possible to obtain a resin molded article in which joint strength is stable and has no variations with respect to molding shots, while maintaining the strength when the first resin molded article and the second molded article are joined.

### BRIEF DESCRIPTION OF THE DRAWINGS

FIG. 1 is a schematic view of an enlarged cross section of a composite molded article 1 of the present embodiment; and

FIG. 2 is a schematic view of an enlarged cross section of a grooved first resin molded article, which is a constituent component of the composite molded article.

### PREFERRED MODE FOR CARRYING OUT THE INVENTION

Below, specific embodiments of the present invention (hereinafter, referred to as a “present embodiment”) are described in detail, with reference to the drawings. Note that the present invention is not limited to the following embodiments, but various modifications are possible within a scope in which the content of the present invention is not changed.

### <Composite Molded Article>

The composite molded article of present embodiment is composed of: a grooved first resin molded article including at least a resin, a glass fiber, and a laser absorbing material and having a groove in which the glass fiber is exposed, and a second molded article disposed adjacent to a grooved surface of the first resin molded article. The composite molded article as described in the present embodiment is characterized in that in the first resin molded article, the glass fiber is mixed in a content of 12 to 45 mass % with respect to the entirety of a resin composition constituting the first resin molded article and the laser absorbing material is mixed in a content of 0.25 to 10 mass % with respect to the entirety of the resin composition; and [{amount (mass %) of the glass fiber contained in a resin composition constituting the first resin molded article×0.9}+{amount (mass %) of the laser absorbing material contained in the resin composition constituting the first resin molded article×1.4}]×{melt viscosity (Pa·s) of a material constituting the second molded article+360}/{average diameter (μm) of the glass fiber contained in the resin composition constituting the first resin molded article×0.8} satisfies 700 or more and 2,500 or less.

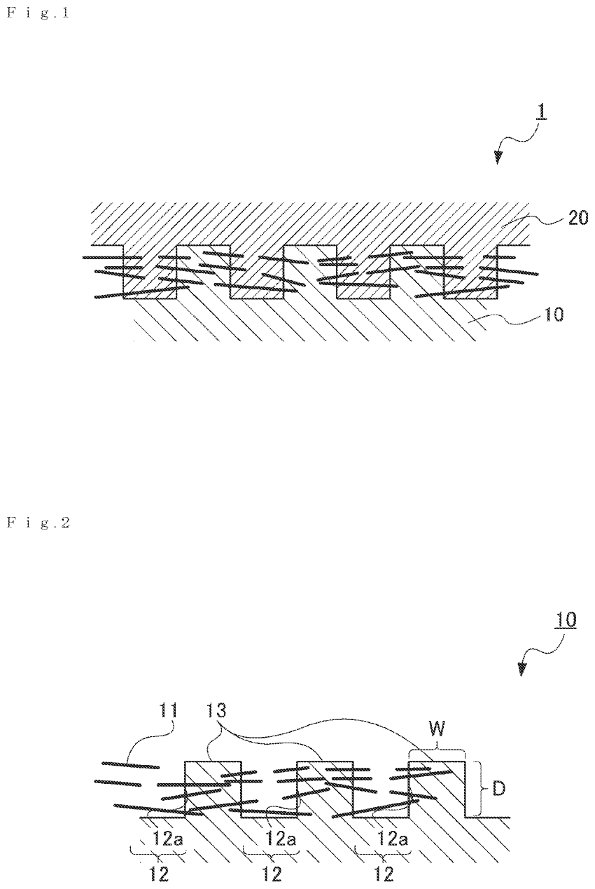

FIG. 1 is a schematic enlarged cross sectional view of the composite molded article of the present embodiment. The composite molded article 1 includes a grooved first resin molded article 10 and a second molded article 20 having protrusions. In the inside of grooves of the grooved first resin molded article 10, glass fibers protrude from side surfaces of the grooves. Further, the protrusions of the second molded article 20 enter into the grooves of the grooved first resin molded article 10 so as to surround protruding glass fibers.

### [Grooved First Resin Molded Article 10]

FIG. 2 is a schematic enlarged cross sectional view of the grooved first resin molded article 10. The grooved first resin molded article 10 includes glass fibers 11. Further, the grooved first resin molded article 10 has grooves 12 in which the glass fibers 11 protrude out of side surfaces thereof and are exposed A portion of the glass fibers bridge the grooves.

### [Resin]

A resin contained in the resin composition constituting the grooved first resin molded article 10 of the present embodiment is not particularly limited as long as it can be removed by irradiation with a laser and a groove 12 can be formed as a result, and may be thermoplastic or thermosetting. Suitable materials for the resin include, for example, polyphenylene sulfide (PPS), liquid crystal polymers (LCP), polybutylene terephthalate (PBT), polyethylene terephthalate (PET), polyacetal (POM), polyamide (PA), and the like.

### [Glass Fiber]

A glass fiber 11 of the present embodiment is made to protrude out of a side surface of the groove and be exposed in the groove formed in the grooved first resin molded article 10 by removing a portion of the resin of the resin molded article. The average fiber length of the glass fiber 11 is not particularly limited, but the glass fiber 11 is characterized by having a length of preferably from 0.1 to 5 mm, and more preferably from 0.5 to 3.5 mm, and an average diameter of preferably from 3 to 20 μm, and more preferably from 8 to 15 μm, in a state before being melt-kneaded into the resin.

Typically, when comparing two identical glass fibers that differ only in diameter and are present in equal amounts (mass %), the glass fiber with the smaller average diameter will be present in a larger number in the same volume compared to the glass fiber with the larger diameter, so that mechanical characteristics such as tensile strength tend to be higher for the glass fiber with the smaller average diameter. However, in the present embodiment, if the average diameter of glass fibers is too small, the number of glass fibers becomes greater as described above, so that attenuation due to reflection and scattering of laser light tends to occur, which decreases removal efficiency of the resin, which may affect the formation of grooves that serve as the basis for an anchor effect. As a result, the joint strength of the grooved first resin molded article and the second molded article decreases, and variations in the joint strength from article to article increase in some cases.

On the other hand, when the average diameter of the glass fibers is too large, it may be difficult to sufficiently enhance mechanical properties of the resin composition itself. From these viewpoints, it is desirable to set the average diameter of the glass fibers to an appropriate range as described above.

The content of the glass fiber is 12 mass % or more and 45 mass % or less with respect to the entirety of the resin composition constituting the grooved first resin molded article. When the content is less than 12 mass %, even if the glass fibers 11 are exposed in the groove 12, there is a possibility that the glass fibers 11 cannot sufficiently serve as an anchor for suppressing breakage of the grooved first resin molded article 10 and the second molded article 20.

When the content is greater than 45 mass %, the laser beam irradiated for the formation of the groove 12 tends to be affected by attenuation by the glass fibers 11, and the variations in the joint strength and the grooved first resin molded article 10 and the second molded article 20 may increase in some cases. The content of the glass fiber is preferably 15 mass % or more and 40 mass % or less, more preferably 20 mass % or more and 38 mass % or less, and most preferably 25 mass % or more and 35 mass % or less. An average fiber length and an average diameter can be determined by reading values of 100 samples in an electron micrograph photo and calculating the average values.

The glass fiber 11 may be used alone or as a mixture, and an inorganic filler other than fibrous inorganic fillers, such as glass flakes, mica, talc, glass beads, or other additives or a reforming agent may be blended to such an extent that exertion of the effect of the present embodiment is not hindered.

In order for the glass fibers 11 exposed in the groove 12 to serve as the anchor for preventing destruction of the grooved first resin molded article 10 and the second molded article 20, it is preferable that the glass fibers 11 appropriately bridge protrusions 13 of recesses and protrusions formed by removing a portion of the resin, in the groove 12.

### [Laser Absorbing Material]

In the present embodiment, it is possible to appropriately adjust easiness of removing the resin (easiness of forming the groove) during laser irradiation, and it is possible to suppress variations in the joint strength by blending 0.25 to 10 mass % of a laser absorbing material with respect to the entirety of the resin composition constituting the grooved first resin molded article 10. In a case in which the content is less than 0.25 mass %, attenuation easily occurs due to reflection and scattering of a laser by the glass fiber and variations in the formation state of the groove easily occurs. In a case in which the content is greater than 10 mass %, in a place where agglomerates of the laser absorbing material are generated or a place where the laser absorbing material aggregates and the concentration thereof becomes high, overheating by the laser occurs and carbides are generated, and thereby the carbides act as failure starting points as foreign matters. Thus, variations in the joint strength easily occurs, likewise.

The content of the laser absorbing material is preferably 0.35 mass % or more and 9 mass % or less, more preferably 0.4 mass % or more and 8 mass % or less, and most preferably 0.5 mass % or more and 6 mass % or less, with respect to the entirety of the resin composition constituting the first resin molded article.

The laser absorbing material of the present embodiment is not particularly limited as long as it can absorb laser light, and for example, a pigment or a dye is used. A pigment, particularly an inorganic pigment, is preferred in terms of absorption efficiency of laser light, and inter alia, carbon black is preferred.

### [Groove]

On a surface of the grooved first resin molded article 10 of the present embodiment, a groove 12 is formed. In the groove 12, glass fibers 11 are exposed. By removing a portion of the resin to form the groove 12 and further removing a portion of the glass fibers that are exposed out of side surfaces at least in the surface side of the groove and that partly shield laser irradiated on the groove, it is possible to expose the glass fibers 11 in a state in which the glass fibers 11 protrude out of side surfaces 12a of the groove 12. By removing at least a portion of the glass fibers 11, it is possible to enhance the anchor effect when complex-molded with another resin molded article.

When obtaining a composite molded article by integrating a grooved first resin molded article with a second molded article, by removing a portion of the glass fibers, among others, glass fibers at the center portion of the groove, in a state in which end portions of the glass fibers that are exposed at least in the surface side protrude, it is possible to facilitate for the second molded article in a flowing state to enter into the groove, which enables a high anchor effect to be obtained.

In the present embodiment, the grooved first resin molded article 10 is integrated with the second molded article 20 through a surface having the groove 12 of the grooved first resin molded article 10 as a contact surface to manufacture the composite molded article 1, but in this composite molded article 1, the glass fibers 11 are no longer exposed. In the present specification, even in a case in which the glass fibers 11 are not exposed in the composite molded article 1, when the second molded article 20 is removed from the composite molded article 1, if the glass fibers 11 are exposed from the groove 12, it is defined that “the glass fibers 11 are exposed in the groove 12”.

When composite-molding the second molded article, by virtue of the glass fibers protruding from side surfaces of the groove and being exposed, a sufficient anchor effect can be obtained more effectively. In this point, the lengthwise direction of the groove 12 is preferably different from the lengthwise direction of the glass fibers 11. Further, when the glass fibers bridge over the groove, the joint effect is further enhanced.

The anchor effect may be further enhanced by forming multiple grooves 12 on a surface of the resin molded article 10. When forming multiple grooves 12, these multiple grooves 12 may be individually formed, or grooves comprising multiple recesses and protrusions may be formed at once in a manner of drawing a figure with a single stroke drawing. The interval of the grooves may be appropriately set in consideration of the ease with which protrusions of the second molded article may enter, difficulty of the exposed glass fibers becoming detached, structural strength of the recesses and protrusions, and the like.

The multiple grooves 12 may be provided such that the grooves 12 each connected at the both ends are aligned like a contour line, or may be formed in a stripe-like pattern where the grooves 12 are not crossed, or may be formed in a grid-like pattern in which the grooves 12 are crossed. In a case in which the grooves 12 are formed in a grid-like pattern, the grooves are preferably formed in a diagonal grid-like pattern in which the lengthwise direction of the grooves 12 is different from the lengthwise direction of glass fibers. Further, in a case in which the grooves 12 are formed in a grid-like pattern, the grooves 12 may be formed in a rhomboidal shape.

There is no particular limitation for the length of the groove 12, and the shape of an opening may be rectangular, or may be circular or elliptical when the groove 12 is short. The groove 12 is preferably long in order to obtain the anchor effect.

Further, there is also no particular limitation for the depth of the groove 12, but it is preferably deeper, because a higher anchor effect can be obtained. In a case in which the depth is small, the grooved first resin molded article 10 may not be tightly joined with the second molded article 20, since a sufficient anchor effect may not be obtained between the glass fibers 11 exposed in the grooves 12 and the second molded article 20 when the second molded article 20 is joined through the grooves 12 to form the composite molded article 1.

### <Second Molded Article and Composite Molded Article>

There is no particular limitation for the material constituting the second molded article 20 of the present embodiment, as long as the material is in an uncured flowable state and can enter into the grooves 12 where the glass fibers 11 are exposed. The material may be any of the following: a thermoplastic resin, a curable resin (a thermosetting resin, a photo-curable resin, a radiation curable resin and the like), rubber, an adhesive, and the like. From the viewpoint of workability, a thermoplastic resin, a thermosetting resin, and a resin composition including rubber, which can be shaped by injection molding, are preferred and a thermoplastic resin composition including a thermoplastic resin is more preferred. It is also possible to use a resin of the same type as or a different type from the resin constituting the first resin molded article. Herein, the different type also encompasses a case in which a resin constituting the first resin molded article is partially included. In the present embodiment, the effect is especially exhibited in the case of different type.

In the present embodiment, the second molded article 20 has a protrusion in contact with the groove 12, and the protrusion enters into the groove 12. It is preferable that the protrusion is disposed inside the groove 12 so as to surround the glass fiber 11. The composite molded article of the present embodiment is formed by laminating a second molded article to a first resin molded article by a method such as injection molding, transfer molding, or welding.

### <Relationship Between Laser Absorbing Material and Components>

In the present embodiment, the content and the average diameter of glass fibers contained in the resin composition constituting the grooved first resin molded article, the content of the laser absorbing material, and the melt viscosity of the material constituting the second molded article mutually affect the joint strength of the obtained composite molded article.

Although the relationship between the diameter and the amount of the glass fibers is as described above, for example, when the diameters of the glass fibers contained in the grooved first resin molded article are small and the content thereof is large, groove formation is disadvantageous due to attenuation of the laser. However, in that case, by increasing the content of the laser absorbing material within a range such that the problem of aggregation does not occur, removal of the resin by the laser is promoted and thereby the influence of the attenuation of the laser can be mitigated.

Further, as the material constituting the second molded article, if a material having a low melt viscosity is used, even when the formation state of grooves is disadvantageous, the protrusions of the second molded article easily enter into the grooves, which results in an advantage in terms of joint strength.

On the other hand, due to requirement that mechanical characteristics or color be matched between the grooved first resin molded article and the second molded article from the viewpoint of product design or design aspects, amounts of the glass fibers or the laser absorbing material such as carbon black to be blended in the material constituting the second molded article may be increased in some cases. In such a case, since the material constituting the second molded article comes to have a high melt viscosity due to an increase in contents of additives, the second molded article becomes difficult to enter into the grooves of the grooved first resin molded article, resulting in disadvantage in joint strength.

In the present embodiment, considering mutual influences of the laser absorbing material and components, the relationship between an amount of glass fibers contained in the resin composition constituting the grooved first resin molded article, an average diameter the glass fibers, an addition amount of the laser absorbing material, and a melt viscosity of the material constituting the second molded article is such that a value obtained by the following equation is 700 or more and 2,500 or less, preferably 1,000 or more and 2,300 or less, and more preferably 1200 or more and 2100 or less: [{amount (mass %) of glass fibers contained in the resin composition constituting the grooved first resin molded article×0.9}+{amount (mass %) of the laser absorbing material contained in the resin composition constituting the grooved first resin molded article×1.4}]×{melt viscosity (Pa·s) of the material constituting the second molded article+360}/{average diameter (μm) of the glass fiber contained in the resin composition constituting the grooved first resin molded article×0.8}.

Note that in the present embodiment, the term “melt viscosity (Pa·s)” refers to a melt viscosity at 1,000 sec-measured according to ISO11443 with respect to a material constituting a molded article. The measurement temperature is as follows: based on a component (e.g., a thermoplastic resin) that is mainly contained in a material constituting a molded article, when the main component has a melting point as in a case of a crystalline resin, the measurement temperature is the melting point of the main component+30° C.; and when the material does not have a clear melting point as in an amorphous resin, the measurement temperature is a temperature of glass transition temperature of the main component+120° C.

### Examples

Below, the present invention is described in more detail with reference to the Examples by typical injection molding, but the present invention shall not be limited to these.

### <Grooved First Resin Molded Article>

Glass fiber ECS03T-786H manufactured by Nippon Electric Glass Co., Ltd. (average fiber length: 3 mm, average diameter: 10.5 μm, hereinafter also described as “GF10.5”) and carbon black #3030B manufactured by Mitsubishi Chemical Co., Ltd. (hereinafter also described as “CB”) as the laser absorbing material were mixed with a liquid crystal polymer (hereinafter also described as “LCP”) manufactured by Polyplastics Co., Ltd. having the melting point of 280° C. and a melt viscosity of 45 Pa·s at 1,000 sec⁻¹ measured at 310° C. according to ISO11443, in amounts described in Table 1 (5 to 50 mass % of GF10.5 and 0.01 to 10.00 mass % of CB with respect to the entirety of a resin composition based on LCP), and rod-shaped molded articles each having a 65 mm×13 mm×6.5 mm size were obtained by injection-molding under the following conditions. A surface of 13 mm×6.5 mm of each of these injection molded articles was irradiated in a direction perpendicular to the surface of the injection-molded article in a diagonal lattice pattern such that the number of irradiations was 10.

The irradiation conditions for all samples were the same: the oscillation wavelength of the laser was 1.064 μm, the maximum rating power was 13 W (average), the output was 90%, the frequency was 40 kHz, and the scanning speed was 1,000 mm/s. In this way, grooved first resin molded articles which had grid-like grooves each with a width of 100 μm were obtained.

### <Molding Conditions of Grooved First Resin Molded Article (Based on LCP)>

Pre-drying: 140° C., 3 hours
Cylinder temperature: 290° C.
Mold temperature: 80° C.
Injection velocity: 100 mm/sec
Pressure holding: 80 MPa (800 kg/cm²)

### <Manufacture of Composite Molded Article by Laminating Second Molded Article>

Each of the grooved first resin molded articles was inserted in a mold for injection-molding having a cavity of 130 mm×13 mm×6.5 mm such that a surface having grooves formed by the laser irritation was arranged as a contact surface. Then, a material constituting a second molded article was injection molded to laminate the second molded article by filling a space of 65 mm×13 mm×6.5 mm that remained in the cavity with the material constituting the second molded article, and thereby a sample of the composite molded article of 130 mm×13 mm×6.5 mm was obtained. Note that as the material constituting the second molded article, the same material as the resin composition constituting the first resin molded article was used and the material was injection molded under the same molding conditions as those for the first resin molded article.

### <Evaluation>

With regard to the sample, 10 specimens were taken out and were subjected to a tensile test in an atmosphere of 23° C. and 50% RH, using Tensilon UTA-50 kN manufactured by Orientec Corporation (crosshead speed of 10 mm/min) and the joint strength of the composite molded articles and variations thereof were evaluated. Evaluation criteria were as described below. With a level of B or higher, no problem occurs in practical use.

A: 10 out of 10 have a joint strength of 12 MPa or more;
B: 10 out of 10 have a joint strength of 10 MPa or more and less than 12 MPa;
C: 8 to 9 out of 10 have a joint strength of 10 MPa or more and the rest has/have a joint strength of less than 10 MPa; and
D: 3 or more out of 10 have a joint strength of less than 10 MPa.

Note that with respect to the respective materials constituting the second molded articles of the respective samples, a melt viscosity (Pa·s) at 1,000 sec⁻¹ measured at 310° C. according to ISO11443 is indicated in parentheses after each of the evaluation results. With respect to each sample, a calculated value of [{amount (mass %) of glass fibers contained in the resin composition constituting the grooved first resin molded article×0.9}+{amount (mass %) of a laser absorbing material contained in the resin composition constituting the grooved first resin molded article×1.4}]×{melt viscosity (Pa·s) of a material constituting the second molded article+360}/{average diameter (μm) of the glass fiber contained in the resin composition constituting the grooved first resin molded article×0.8} is indicated in the second line of the respective evaluation results.

TABLE 1

| | | GF10.5 (mass %) | | | | | | | |
|---|---|---|---|---|---|---|---|---|---|
| | | 5 | 10 | 15 | 25 | 30 | 35 | 40 | 50 |
| CB | 10.00 | D (50) | C (58) | B (66) | B (75) | B (82) | C (93) | C (101) | D (110) |
| (mass %) | | 914 | 1160 | 1416 | 1923 | 2197 | 2504 | 2804 | 3378 |
| | 7.50 | D (51) | C (59) | B (67) | A (76) | A (83) | B (94) | C (102) | D (111) |
| | | 739 | 980 | 1231 | 1731 | 2001 | 2300 | 2594 | 3160 |
| | 5.00 | D (51) | C (59) | B (67) | A (76) | A (83) | A (94) | B (102) | C (111) |
| | | 565 | 802 | 1048 | 1541 | 1806 | 2098 | 2386 | 2944 |
| | 3.00 | D (51) | C (59) | B (67) | A (76) | A (83) | A (94) | B (102) | C (111) |
| | | 426 | 660 | 902 | 1390 | 1651 | 1937 | 2221 | 2772 |
| | 1.00 | D (51) | C (59) | B (67) | A (76) | A (83) | A (94) | A (102) | C (111) |
| | | 288 | 518 | 757 | 1240 | 1497 | 1778 | 2057 | 2602 |
| | 0.50 | D (51) | C (59) | B (67) | A (76) | A (83) | A (94) | A (102) | C (111) |
| | | 254 | 483 | 721 | 1202 | 1459 | 1738 | 2016 | 2560 |
| | 0.40 | D (51) | C (59) | B (67) | B (76) | A (83) | A (94) | A (103) | C (112) |
| | | 247 | 476 | 713 | 1195 | 1451 | 1730 | 2008 | 2552 |
| | 0.30 | D (52) | C (60) | B (68) | B (78) | B (85) | B (96) | B (105) | C (114) |
| | | 240 | 469 | 706 | 1188 | 1444 | 1722 | 2000 | 2543 |
| | 0.20 | D (53) | D (61) | C (70) | B (79) | B (87) | B (98) | C (107) | C (116) |
| | | 233 | 462 | 699 | 1180 | 1436 | 1715 | 1992 | 2535 |
| | 0.10 | D (54) | D (63) | C (71) | C (81) | C (89) | C (100) | D (109) | D (119) |
| | | 227 | 455 | 692 | 1173 | 1428 | 1707 | 1984 | 2526 |
| | 0.01 | D (55) | D (64) | D (73) | D (83) | C (91) | D (103) | D (112) | D (121) |
| | | 220 | 449 | 685 | 1166 | 1421 | 1700 | 1976 | 2519 |

Subsequently, glass fiber ECS03T-786H manufactured by Nippon Electric Glass Co., Ltd. (average fiber length: 3 mm, average diameter: 10.5 μm, hereinafter also described as “GF10.5”) or glass fiber ECS03T-717 manufactured by Nippon Electric Glass Co., Ltd. (average fiber length: 3 mm, average diameter: 13 μm, hereinafter also described as “GF13”) and carbon black #3030B manufactured by Mitsubishi Chemical Co., Ltd. (hereinafter also described as “CB”) as the laser absorbing material were mixed with a polyphenylene sulfide resin (hereinafter also described as “PPS”) manufactured by Polyplastics Co., Ltd. having the melting point of 280° C. and a melt viscosity of 130 Pa·s at 1,000 sec⁻¹ measured at 310° C. according to ISO11443, in amounts described in Table 2 (5 to 35 mass % of GF10.5 or GF13 and 5.0 mass % of CB with respect to the entirety of a resin composition based on PPS), and rod-shaped molded articles each having a 65 mm×13 mm×6.5 mm size were obtained by injection-molding under the following conditions.

With each of these injection molded articles, in the same manner as in the Examples regarding the LCP-based injection molded articles described above, a surface of 13 mm×6.5 mm was irradiated with laser to manufacture a grooved first resin molded article, which was inserted in a mold for injection-molding having a cavity of 130 mm×13 mm×6.5 mm such that a surface having grooves was arranged as a contact surface. Then, a material constituting a second molded article was injection molded to laminate the second molded article by filling a space of 65 mm×13 mm×6.5 mm that remained in the cavity with the material constituting the second molded article, and thereby a sample of a composite molded article of 130 mm×13 mm×6.5 mm was obtained. Note that as the material constituting the second molded article, the same material as the resin composition constituting the first resin molded article was used and the material was injection molded under the same molding conditions as those for the first resin molded article.

### <Molding Conditions of PPS-Based Resin Molded Article>

Pre-drying: 140° C., 3 hours

Cylinder temperature: 320° C.
Mold temperature: 140° C.
Injection velocity: 30 mm/sec
Pressure holding: 80 MPa (800 kg/cm²)

### <Evaluation>

With regard to the sample, 10 specimens were taken out and were subjected to a tensile test in an atmosphere of 23° C. and 50% RH, using Tensilon UTA-50 kN manufactured by Orientec Corporation (crosshead speed of 10 mm/min) and the joint strength of the composite molded articles and variations thereof were evaluated. Evaluation criteria were as described below. With a level of B or higher, no problem occurs in practical use.

A: 10 out of 10 have a joint strength of 40 MPa or more;
B: 10 out of 10 have a joint strength of 30 MPa or more and less than 40 MPa;
C: 8 to 9 out of 10 have a joint strength of 30 MPa or more and 1 or 2 have a joint strength of less than 30 MPa; and
D: 3 or more out of 10 have a joint strength of less than 30 MPa.

Note that with respect to the material constituting the second molded articles of the respective samples, a melt viscosity (Pa·s) at 1,000 sec⁻¹ measured at 310° C. according to ISO11443 is indicated in parentheses after each of the evaluation results. With respect to each sample, a calculated value of [{amount (mass %) of glass fibers contained in the resin composition constituting the grooved first resin molded article×0.9}+{amount (mass %) of a laser absorbing material contained in the resin composition constituting the grooved first resin molded article×1.4}]×{melt viscosity (Pa·s) of a material constituting the second molded article+360}/{average diameter (μm) of the glass fiber contained in the resin composition constituting the grooved first resin molded article×0.8} is indicated in the second line of the respective evaluation results.

TABLE 2

| | | CB (mass %) |
|---|---|---|
| | | 5.00 |
| GF10.5 | 5 | D (235) |
| (mass %) | | 616 |
| | 15 | A (281) |
| | | 1351 |
| | 25 | B (332) |
| | | 2196 |
| | 35 | C (370) |
| | | 3102 |
| GF13 | 5 | D (227) |
| (mass %) | | 491 |
| | 15 | B (278) |
| | | 1086 |
| | 25 | A (320) |
| | | 1746 |
| | 35 | B (364) |
| | | 2485 |

Furthermore, glass fiber ECS03T-786H manufactured by Nippon Electric Glass Co., Ltd. (average fiber length: 3 mm, average diameter: 10.5 μm, hereinafter also described as “GF10.5”) and carbon black #3030B manufactured by Mitsubishi Chemical Co., Ltd. (hereinafter also described as “CB”) as the laser absorbing material were mixed with a polyphenylene sulfide resin (hereinafter also described as “PPS”) manufactured by Polyplastics Co., Ltd. having the melting point of 280° C. and a melt viscosity of 130 Pa·s at 1,000 sec⁻¹ measured at 310° C. according to ISO11443, in amounts described in Table 3 (5 to 50 mass % of GF10.5 and 0.01 to 10.00 mass % of CB with respect to the entirety of a resin composition based on PPS), and rod-shaped molded articles each having a 65 mm×13 mm×6.5 mm size were obtained by injection-molding under the following conditions.

With each of these injection molded articles, in the same manner as in the Examples regarding the LCP-based injection molded articles described above, a surface of 13 mm×6.5 mm was irradiated with laser to manufacture a grooved first resin molded article, which was inserted in a mold for injection-molding having a cavity of 130 mm×13 mm×6.5 mm such that a surface having grooves was arranged as a contact surface. Then, a material constituting a second molded article was injection molded to laminate the second molded article by filling a space of 65 mm×13 mm×6.5 mm that remained in the cavity with the material constituting the second molded article, and thereby a sample of a composite molded article of 130 mm×13 mm×6.5 mm was obtained. Note that as the material constituting the second molded article, a polyoxymethylene resin manufactured by Polyplastics Co., Ltd. (hereinafter also described as “POM”) having the melting point of 165° C. and a melt viscosity of 278 Pa·s at a 1,000 sec⁻¹ measured at 195° C. according to ISO11443 was used and the injection molding was performed under the following conditions.

### <Molding Conditions of POM>

Pre-drying: 80° C., 3 hours

Cylinder temperature: 195° C.
Mold temperature: 80° C.
Injection velocity: 16 mm/sec
Pressure holding: 80 MPa (800 kg/cm²)

### <Evaluation>

With regard to the sample, 10 specimens were taken out and were subjected to a tensile test in an atmosphere of 23° C. and 50% RH, using Tensilon UTA-50 kN manufactured by Orientec Corporation (crosshead speed of 10 mm/min) and the joint strength of the composite molded articles and variations thereof were evaluated. Evaluation criteria were as described below. With a level of B or higher, no problem occurs in practical use.

A: 10 out of 10 have a joint strength of 10 MPa or more;
B: 10 out of 10 have a joint strength of 7 MPa or more and less than 10 MPa;
C: 8 to 9 out of 10 have a joint strength of 7 MPa or more and 1 or 2 have a joint strength of less than 7 MPa; and
D: 3 or more out of 10 have a joint strength of less than 7 MPa.

Note that with respect to the material constituting the second molded articles of the respective samples, a melt viscosity (278 Pa·s) at 1,000 sec⁻¹ measured at 195° C. according to ISO11443 is indicated in parentheses after each of the evaluation results. With respect to each sample, a calculated value of [{amount (mass %) of glass fibers contained in the resin composition constituting the grooved first resin molded article×0.9}+{amount (mass %) of a laser absorbing material contained in the resin composition constituting the grooved first resin molded article×1.4}]×{melt viscosity (Pa·s) of a material constituting the second molded article+360}/{average diameter (μm) of the glass fiber contained in the resin composition constituting the grooved first resin molded article×0.8} is indicated in the second line of the respective evaluation results.

TABLE 3

| | | GF10.5 (mass %) | | | | |
|---|---|---|---|---|---|---|
| | | 5 | 15 | 25 | 35 | 50 |
| CB | 10.00 | D (278) | B (278) | C (278) | C (278) | D (278) |
| (mass %) | | 1405 | 2089 | 2772 | 3456 | 4481 |
| | 5.00 | D (278) | B (278) | B (278) | C (278) | D (278) |
| | | 873 | 1557 | 2241 | 2924 | 3950 |
| | 1.00 | D (278) | B (278) | A (278) | B (278) | C (278) |
| | | 448 | 1132 | 1815 | 2499 | 3524 |
| | 0.50 | D (278) | B (278) | A (278) | B (278) | C (278) |
| | | 395 | 1079 | 1762 | 2446 | 3471 |
| | 0.30 | D (278) | B (278) | B (278) | B (278) | C (278) |
| | | 374 | 1057 | 1741 | 2424 | 3450 |
| | 0.10 | D (278) | C (278) | C (278) | C (278) | D (278) |
| | | 352 | 1036 | 1720 | 2403 | 3428 |

Based on the above-described results, in the scope of the present invention, composite resin articles having a high joint strength could be obtained and variations in the joint strength could be reduced.

### EXPLANATION OF REFERENCE NUMERALS

1 Composite molded article
10 Grooved first resin molded article
11 Inorganic filler
12 Groove
12a Side wall of groove
13 Protrusion
20 Second molded article
D Depth of groove
W Width of protrusion

1. A composite molded article comprising:
a grooved first resin molded article comprising at least a resin, a glass fiber, and a laser absorbing material and having a groove in which the glass fiber is exposed, and
a second resin molded article disposed adjacent to a grooved surface of the first resin molded article,
with the composite molded article being an insert injection molded article,
wherein, in the first resin molded article, the glass fiber is mixed in a content of 15 to 40 mass % with respect to an entirety of a resin composition constituting the first resin molded article, and
the laser absorbing material is mixed in a content of 25 0.30 to 10 mass % with respect to the entirety of the resin composition constituting the first resin molded article, and
wherein [{amount (mass %) of the glass fiber contained in the resin composition constituting the first resin molded article×0.9}+{amount (mass %) of the laser absorbing material contained in the resin composition constituting the first resin molded article×1.4}]×{melt viscosity (Pa·s) of a material constituting the second molded article+360}/{average diameter (μm) of the glass fiber contained in the resin composition constituting the first resin molded article×0.8} satisfies 700 or more and 2,500 or less.

2. The composite molded article according to claim 1, wherein the glass fiber is mixed in a content of 20 to 35 mass % with respect to the entirety of the resin composition constituting the first resin molded article, and the laser absorbing material is mixed in a content of 0.35 to 7.5 mass % with respect to the entirety of the resin composition constituting the first resin molded article.

3. The composite molded article according to claim 1, wherein [{amount (mass %) of the glass fiber contained in the resin composition constituting the first resin molded article×0.9}+{amount (mass %) of the laser absorbing material contained in the resin composition constituting the first resin molded article×1.4}]×{melt viscosity (Pa·s) of the material constituting the second resin molded article+360}/{average diameter (μm) of the glass fiber contained in the resin composition constituting the first resin molded article×0.8} satisfies 1,200 or more and 2,100 or less.

4. The composite molded article according to claim 1, wherein the resin constituting the first resin molded article and the resin constituting the second resin molded article are different types.
